(19) United States
(12) Patent Application Publication
(10) Pub. No.: US 2026/0099684 A1
(43) Pub. Date: Apr. 9, 2026

(54) LEARNING METHOD DETERMINATION DEVICE, LEARNING METHOD DETERMINATION METHOD, AND NON-TRANSITORY COMPUTER READABLE MEDIUM STORING LEARNING METHOD DETERMINATION PROGRAM FOR SUPPORTING DECISION MAKING

(71) Applicant: NEC Corporation, Tokyo (JP)

(72) Inventors: Kosuke Akimoto, Tokyo (JP); Masafumi Oyamada, Tokyo (JP)

(73) Assignee: NEC Corporation, Tokyo (JP)

(21) Appl. No.: 19/344,625

(22) Filed: Sep. 30, 2025

(30) Foreign Application Priority Data
Oct. 8, 2024 (JP) 2024-176659

(51) Int. Cl. G06F 40/40; G06N 20/00

(52) U.S. Cl. CPC G06F 40/40; G06N 20/00

(57) ABSTRACT

A language model is efficiently trained. A learning method determination device includes an acquisition unit for acquiring a first calculation resource amount that is a constraint on a calculation resource amount used for learning processing of a language model and a target language resource amount that is a resource amount of an available target language, a threshold determination unit for referring to the first calculation resource amount and determining a first threshold to be referred to for determining a schedule of the learning processing, a comparison unit for comparing the target language resource amount with the first threshold, and a schedule determination unit for referring to a comparison result and determining the schedule.

### INCORPORATION BY REFERENCE

This application is based upon and claims the benefit of priority from Japanese patent application No. 2024-176659, filed on October 8, 2024, the disclosure of which is incorporated herein in its entirety by reference.

### TECHNICAL FIELD

The present disclosure relates to a learning method determination device, a learning method determination method, and a non-transitory computer readable medium having stored therein a learning method determination program for supporting decision making.

### BACKGROUND ART

A technique related to learning of a language model is known. For example, “Continual Pre-Training for Cross-Lingual LLM Adaptation: Enhancing Japanese Language Capabilities” (Kazuki Fujii et al, [online], April 27, 2024, Internet <URL: https://arxiv.org/pdf/2404.17790>) discloses a technique for training (two-stage training) a language model trained by an English corpus by using a Japanese corpus.

### SUMMARY

In the technique described in “Continual Pre-Training for Cross-Lingual LLM Adaptation: Enhancing Japanese Language Capabilities” (Kazuki Fujii et al, [online], April 27, 2024, Internet <URL: https://arxiv.org/pdf/2404.17790>), how to change, during learning, the ratio between the English corpus and the Japanese corpus in learning to be efficient has not been studied. In other words, in the technique described in “Continual Pre-Training for Cross-Lingual LLM Adaptation: Enhancing Japanese Language Capabilities” (Kazuki Fujii et al, [online], April 27, 2024, Internet <URL: https://arxiv.org/pdf/2404.17790>), the ratio between Japanese, which is the target language of the language model, and English, which is used supplementarily, has not been studied for the corpus (language resource amount) used for learning. Therefore, a technique for training a language model more efficiently than the technique described in “Continual Pre-Training for Cross-Lingual LLM Adaptation: Enhancing Japanese Language Capabilities” (Kazuki Fujii et al, [online], April 27, 2024, Internet <URL: https://arxiv.org/pdf/2404.17790>) is required.

The present disclosure has been made in view of the above problems, and an example object thereof is to provide a technique for efficiently training a language model.

A learning method determination device according to an example aspect of the present disclosure includes an acquisition means for acquiring a first calculation resource amount and a target language resource amount, the first calculation resource amount being a constraint on a calculation resource amount used for learning processing of a language model for a target language, the target language resource amount being a resource amount of the target language available in the learning processing, a threshold determination means for determining a first threshold to be referred to for determining a schedule of a rate at which the target language resource amount is used in the language resource amount used in the learning processing of the language model with reference to the first calculation resource amount, a comparison means for comparing the target language resource amount with the first threshold, and a schedule determination means for determining the schedule with reference to a comparison result by a comparison means.

A learning method determination method according to an example aspect of the present disclosure includes acquisition processing of acquiring, by at least one processor, a first calculation resource amount that is a constraint on a calculation resource amount used for learning processing of a language model for a target language and a target language resource amount that is a resource amount of the target language available in the learning processing, threshold determination processing of determining, by the at least one processor, a first threshold to be referred to for determining a schedule of a rate at which the target language resource amount is used in the language resource amount used in the learning processing of the language model with reference to the first calculation resource amount, comparison processing of comparing, by the at least one processor, the target language resource amount with the first threshold, and schedule determination processing of determining, by the at least one processor, the schedule with reference to a comparison result in the comparison processing.

A learning method determination program according to an example aspect of the present disclosure is a program for causing a computer to function as a learning method determination device, in which the computer functions as an acquisition means for acquiring a first calculation resource amount that is a constraint on a calculation resource amount used for learning processing of a language model for a target language and a target language resource amount that is a resource amount of the target language available in the learning processing, a threshold determination means for determining a first threshold to be referred to for determining a schedule of a rate at which the target language resource amount is used in the language resource amount used in the learning processing of the language model with reference to the first calculation resource amount, a comparison means for comparing the target language resource amount with the first threshold, and a schedule determination means for determining the schedule with reference to a comparison result by the comparison means.

According to an example aspect of the present disclosure, there is an example effect that a technology for efficiently training a language model can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a learning method determination device according to the present disclosure;

FIG. 2 is a flowchart illustrating a flow of a learning method determination method according to the present disclosure;

FIG. 3 is a graph illustrating a relationship between a unique amount of a text corpus of a target language and a loss according to the present disclosure;

FIG. 4 is a block diagram illustrating a configuration of a learning method determination device according to the present disclosure;

FIG. 5 is a flowchart illustrating a flow of a learning method determination method according to the present disclosure; and

FIG. 6 is a block diagram illustrating a configuration of a computer that functions as a learning method determination device according to the present disclosure.

### EXAMPLE EMBODIMENT

Hereinafter, example embodiments of the present disclosure will be exemplified. However, the present disclosure is not limited to the following illustrative example embodiments, and various modifications can be made within a scope described in the claims. For example, example embodiments obtained by appropriately combining technologies (some or all of things or methods) adopted in the following illustrative example embodiments can also be included in the scope of the present disclosure. Example embodiments obtained by appropriately omitting some of the technologies adopted in the following illustrative example embodiments can also be included in the scope of the present disclosure. Effects mentioned in the following illustrative example embodiments are examples of effects expected in the illustrative example embodiments, and do not define extension of the present disclosure. In other words, example embodiments that do not provide the effects mentioned in the following illustrative example embodiments can also be included in the scope of the present disclosure.

### First Illustrative Example Embodiment

A first illustrative example embodiment that is an example of the example embodiments of the present disclosure will be described in detail with reference to the drawings. The present illustrative example embodiment is a basic form of each illustrative example embodiment to be described below. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technology illustrated in the drawings referred to for describing the present illustrative example embodiment can also be adopted in another illustrative example embodiment included in the present disclosure within a range in which no particular technical problem occurs.

### Configuration of Learning Method Determination Device 1

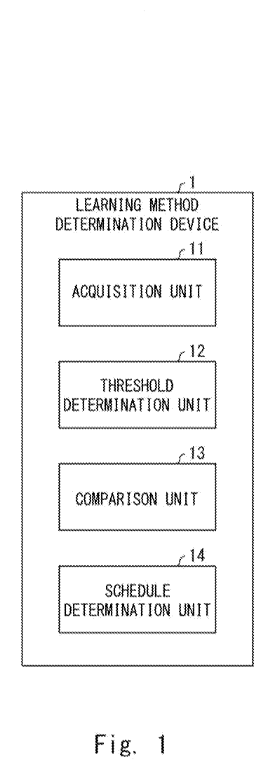

A configuration of a learning method determination device 1 will be described with reference to FIG. 1. FIG. 1 is a block diagram illustrating the configuration of the learning method determination device 1. As illustrated in FIG. 1, the learning method determination device 1 includes an acquisition unit 11, a threshold determination unit 12, a comparison unit 13, and a schedule determination unit 14.

### Acquisition Unit 11

The acquisition unit 11 acquires a first calculation resource amount that is a constraint on a calculation resource amount used for learning processing of a language model for a target language and a target language resource amount that is a resource amount of the target language available in the learning processing. The acquisition unit 11 supplies the acquired first calculation resource amount to the threshold determination unit 12. The acquisition unit 11 supplies the acquired target language resource amount to the comparison unit 13.

### Threshold Determination Unit 12

The threshold determination unit 12 refers to the first calculation resource amount, and determines a first threshold that is referred to for determining a schedule of learning processing of the language model that is a schedule of a ratio at which the target language resource amount is used among the language resource amount used in the learning processing of the language model. The threshold determination unit 12 supplies the determined first threshold to the comparison unit 13.

### Comparison Unit 13

The comparison unit 13 compares the target language resource amount with the first threshold. The comparison unit 13 supplies the comparison result to the schedule determination unit 14.

### Schedule Determination Unit 14

The schedule determination unit 14 refers to the comparison result by the comparison unit 13, and determines a schedule of a ratio at which the target language resource amount is used among the language resource amount used in the learning processing of the language model.

### Effect of Learning Method Determination Device 1

As described above, the learning method determination device 1 employs a configuration including the acquisition unit 11 that acquires the first calculation resource amount that is a constraint on the calculation resource amount used in the learning processing of the language model for the target language and the target language resource amount that is the resource amount of the target language available in the learning processing, the threshold determination unit 12 that refers to the first calculation resource amount and determines the first threshold that is referred to for determining the schedule of the ratio in which the target language resource amount is used in the learning processing of the language model, the comparison unit 13 that compares the target language resource amount with the first threshold, and the schedule determination unit 14 that refers to the comparison result by the comparison unit 13 and determines the schedule of the ratio in which the target language resource amount is used in the learning processing of the language model.

Therefore, according to the learning method determination device 1, it is possible to obtain an effect that the language model can be efficiently trained.

### Flow of Learning Method Determination Method

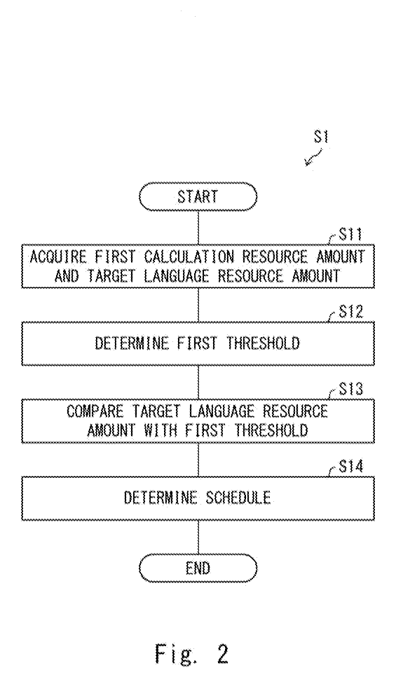

A flow of a learning method determination method S1 will be described with reference to FIG. 2. FIG. 2 is a flowchart illustrating the flow of the learning method determination method S1. As illustrated in FIG. 2, the learning method determination method S1 includes acquisition processing S11, threshold determination processing S12, comparison processing S13, and schedule determination processing S14.

### Acquisition Processing S11

In the acquisition processing S11, the acquisition unit 11 acquires a first calculation resource amount that is a constraint on a calculation resource amount used for learning processing of a language model for a target language and a target language resource amount that is a resource amount of the target language available in the learning processing. The acquisition unit 11 supplies the acquired first calculation resource amount to the threshold determination unit 12. The acquisition unit 11 supplies the acquired target language resource amount to the comparison unit 13.

### Threshold Determination Processing S12

In the threshold determination processing S12, the threshold determination unit 12 refers to the first calculation resource amount, and determines a first threshold that is referred to for determining a schedule of learning processing of the language model that is a schedule of a ratio at which the target language resource amount is used among the language resource amount used in the learning processing of the language model. The threshold determination unit 12 supplies the determined first threshold to the comparison unit 13.

### Comparison Processing S13

In the comparison processing S13, the comparison unit 13 compares the target language resource amount with the first threshold. The comparison unit 13 supplies the comparison result to the schedule determination unit 14.

### Schedule Determination Processing S14

In the schedule determination processing S14, the schedule determination unit 14 refers to the comparison result by the comparison unit 13, and determines a schedule of a ratio at which the target language resource amount is used in the language resource amount used in the learning processing of the language model.

### Effect of Learning Method Determination Method S1

As described above, the learning method determination method S1 employs a configuration including the acquisition processing S11 in which the acquisition unit 11 acquires the first calculation resource amount that is a constraint on the calculation resource amount used in the learning processing of the language model for the target language and the target language resource amount that is the resource amount of the target language available in the learning processing, the threshold determination processing S12 in which the threshold determination unit 12 refers to the first calculation resource amount and determines the first threshold that is referred to for determining the schedule of the ratio in which the target language resource amount is used in the learning processing of the language model, the comparison processing S13 in which the comparison unit 13 compares the target language resource amount with the first threshold, and the schedule determination processing S14 in which the schedule determination unit 14 refers to the comparison result by the comparison unit 13 and determines the schedule of the ratio in which the target language resource amount is used in the learning processing of the language model. Therefore, according to the learning method determination method S1, an effect similar to that of the learning method determination device 1 described above can be obtained.

### Second Illustrative Example Embodiment

A second illustrative example embodiment that is an example of the example embodiments of the present disclosure will be described in detail with reference to the drawings. Components that have the same functions as the components described in the above-described illustrative example embodiment are denoted by the same reference signs, and description of the components will be appropriately omitted. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in each of the drawings referred to for description of the present illustrative example embodiment can be employed in the other illustrative example embodiments included in the present disclosure within a range in which no particular technical problem occurs.

Learning a language model (hereinafter, also referred to as “LLM (Large Language Models)”) requires a large text corpus. However, languages other than English have a relatively small text corpus. Therefore, the following method is known as a method for training a language model using a language having a small resource amount of a text corpus as a target language.

Method of performing learning by repeatedly using the same text corpus a plurality of times (multi-epoch learning)

Method of performing learning using a text corpus of another language different from the target language in addition to a text corpus of the target language (multilingual learning)

Method of performing two-stage learning by changing in stages a language ratio between a target language and another language in multilingual learning (two-stage learning)

However, in a case where the language model is trained by combining the above-described methods, the learning setting (hyperparameter) increases, and thus, the cost increases if exhaustive search is performed.

Therefore, the engineer who trains the language model has heuristically narrowed down the search space based on the analysis result obtained in the past regarding the performance change of the language model by the learning setting. However, the analysis related to the learning setting of the language model performed in the past is limited, and there is a problem that the optimal search space cannot be narrowed in a case where the LLM is trained by combining the above-described methods.

Therefore, the inventors of the present disclosure have conducted studies to narrow down a search space of a learning setting expected to obtain high performance in a case where a language model having a language with a small resource amount as a target language is trained by using a combination of a part or all of the multi-epoch learning, the multilingual learning, and the two-stage learning described above.

As an example, the present inventor has obtained knowledge that, in a case where the calculation resource amount of processing for training LLM is fixed to a certain value, the optimal learning method changes depending on whether the unique amount (a quantity that does not include repetition in a case where the number of epochs is more than one) of the text corpus of the target language used in the learning processing is equal to or more than a certain threshold or less than the certain threshold.

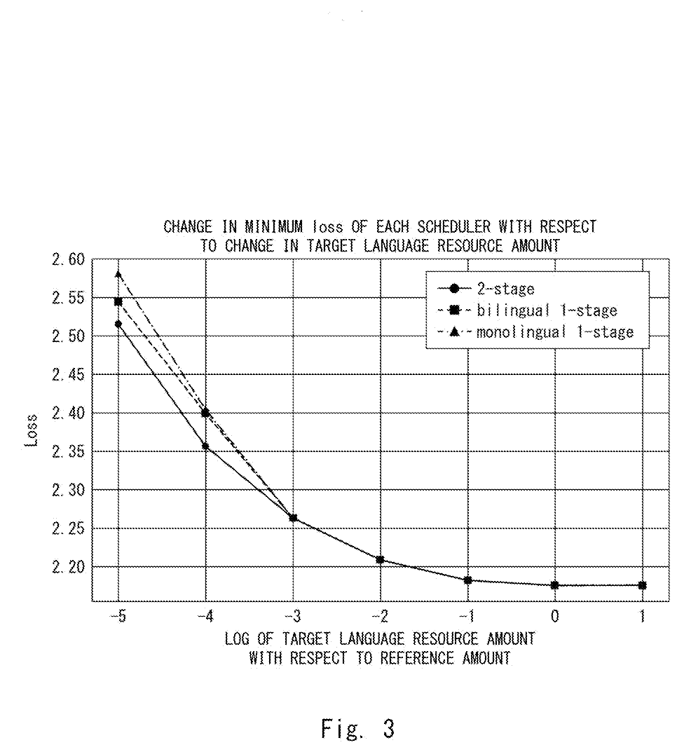

FIG. 3 illustrates a graph that is the basis of the findings obtained by the present inventors. FIG. 3 is a graph illustrating a relationship between a unique amount of a text corpus of a target language and a loss. The graph in FIG. 3 is a graph in a case where the target language is Japanese.

In the graph illustrated in FIG. 3, the horizontal axis represents a logarithmic value with a base of 2 of magnitude with respect to the reference amount regarding the unique amount of the text corpus of the target language. The vertical axis is the minimum value of the loss of an LLM that can be achieved in the unique amount of the relevant text corpus, and the smaller the value, the better the performance of an LLM. A one-dot chain line indicates multi-epoch learning using only the target language, a dotted line indicates multilingual learning, and a solid line indicates two-stage learning.

In FIG. 3, it is illustrated that in a case where the value of the horizontal axis is from -5 to -3 (in a case where the unique amount of the text corpus is small), the performance of an LLM is the best in a case where two-stage learning is used, and in a case where the value of the horizontal axis is -3 or more (in a case where the unique amount of the text corpus is large), the performance does not change in any learning. Here, multi-epoch learning, multilingual learning, and two-stage learning are in an inclusion relationship, two-stage learning includes multilingual learning, and multilingual learning includes multi-epoch learning. Therefore, in a case where the value of the horizontal axis is -3 or more in which the performance does not change in any learning, multi-epoch learning is the optimal learning method.

That is, the inventor has obtained knowledge that multilingual learning is an optimal learning method in a case where the unique amount of the text corpus is less than a certain threshold, and multi-epoch learning is an optimal learning method in a case where the unique amount of the text corpus is equal to or more than a certain threshold.

A learning method determination device 1A and each process performed by the learning method determination device 1A to be described below are based on the above-described knowledge, and are based on a viewpoint unique to the inventor.

### Outline of Learning Method Determination Device 1A

The learning method determination device 1A is a device that determines an appropriate learning method in LLM learning. The appropriate learning method is a learning method having a small loss in learning. In the present disclosure, as an example, the learning method determination device 1A determines which of the multi-epoch learning and the two-stage learning is an appropriate learning method. In other words, in the learning of the LLM, the learning method determination device 1A is a device that determines, according to what schedule, it is appropriate to change the ratio at which the target language resource amount that is the resource amount of the target language of the LLM is used in the language resource amount used for learning (whether the loss is small).

Specifically, the learning method determination device 1A determines a first threshold TH1 with reference to a first calculation resource amount CR1 that is a constraint on the calculation resource amount used for the learning processing of the LLM for the target language. Then, the learning method determination device 1A determines an appropriate learning method based on a comparison result between the first threshold TH1 and the target language resource amount T_unique that is the resource amount of the target language available in the learning processing.

The first calculation resource amount CR1, which is a constraint on the calculation resource amount used for the LLM learning processing for the target language, is the resource amount that can be used for the learning processing by the device that performs the LLM learning processing, and as an example, an amount obtained by measuring the total amount of calculation that can be used for the learning processing in units of a floating-point operation (FLOP) can be cited.

The target language resource amount T_unique, which is the resource amount of the target language available in the learning processing, is the unique amount (a quantity that does not include repetition in a case where the number of epochs is more than one) of the text corpus of the target language that has been collected and can be used to perform the LLM learning processing. An example of the target language resource amount T_unique is the unique amount of the text corpus of all the target languages existing on the earth.

The “language” in the present disclosure includes words and sentences used in a specific field (domain) such as dialect and medical care, in addition to natural languages such as Japanese and English.

The “language resource amount” in the present disclosure is not particularly limited, and may be a resource amount of any language, or may be a resource amount of a language used in any processing (processing of entire learning, processing in one or more epochs, processing in one or more stages, processing in one or more steps, and the like). In a case where the number of epochs is two or more, the resource amount may be a resource amount excluding duplication or a resource amount including duplication.

As another example of the learning method determined by the learning method determination device 1A, there is a method of performing learning by changing a language ratio between a target language and a plurality of other languages in a plurality of stages in multilingual learning. For example, three-stage learning in which the language ratio between the target language and the other two languages is changed in three stages, and four-stage learning in which the language ratio between the target language and the other three languages is changed in four stages can be cited. As still another example, there is a method of performing learning by changing the language ratio in units of steps.

The learning method determination device 1A may be configured to determine a plurality of first thresholds TH1. For example, in a case where the learning method determination device 1A selects any one of a plurality of learning methods, the plurality of first thresholds TH1 relevant to the number of the plurality of learning methods may be determined.

### Configuration of Learning Method Determination Device 1A

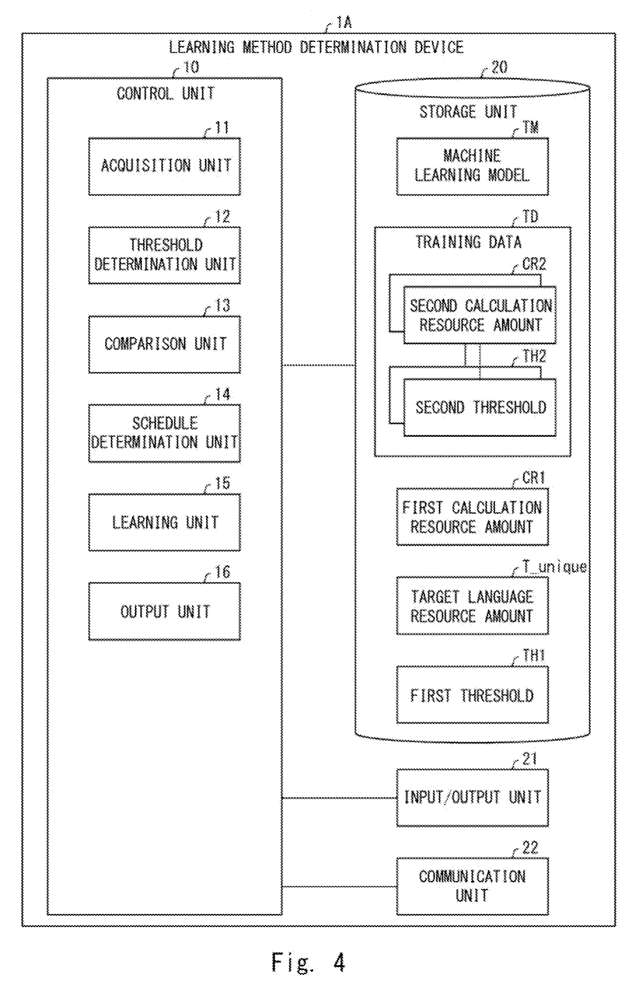

A configuration of the learning method determination device 1A will be described with reference to FIG. 4. FIG. 4 is a block diagram illustrating a configuration of the learning method determination device 1A. As illustrated in FIG. 4, the learning method determination device 1A includes a control unit 10, a storage unit 20, an input/output unit 21, and a communication unit 22.

### Storage Unit 20

The storage unit 20 stores data to be referred to by the control unit 10. As an example, as illustrated in FIG. 4, the storage unit 20 stores a machine learning model TM, training data TD, a first calculation resource amount CR1, a target language resource amount T_unique, and a first threshold TH1.

The machine learning model TM is a machine learning model (regression model) trained using the training data TD so as to output a threshold relevant to the calculation resource amount with the calculation resource amount as an input. The fact that the machine learning model TM is stored in the storage unit 20 indicates that a parameter defining the machine learning model TM is stored in the storage unit 20.

The training data TD is data used for learning of the machine learning model TM. As illustrated in FIG. 4, the training data TD is data including a plurality of sets of a second calculation resource amount CR2 and a second threshold TH2. The value of the second calculation resource amount CR2 is not particularly limited, but as an example, the second calculation resource amount CR2 is smaller than the first calculation resource amount CR1. Processing of training the machine learning model TM using the training data TD will be described later.

The first calculation resource amount CR1 and the target language resource amount T_unique are as described above.

The first threshold TH1 is referred to for determining a schedule of the LLM learning processing that is a schedule of a ratio in which the target language resource amount T_unique is used among the language resource amount used in the LLM learning processing. A method for determining the first threshold TH1 will be described later.

### Input/Output Unit 21

The input/output unit 21 is an interface with an input device that receives an input of data and an output device that outputs data. Examples of the input device include, but are not limited to, a microphone, a camera, a line-of-sight input device, a keyboard, and a touch pad. Examples of the output device include, but are not limited to, a speaker and a liquid crystal display.

### Communication Unit 22

The communication unit 22 is an interface for transmitting and receiving data via a network. Examples of the communication unit 22 include, but are not limited to, communication chips in various communication standards such as Ethernet (registered trademark), Wi-Fi (registered trademark), and wireless communication standards of mobile data communication networks, and connectors compliant with USB.

### Control Unit 10

The control unit 10 controls each component included in the learning method determination device 1A. As illustrated in FIG. 4, the control unit 10 includes an acquisition unit 11, a threshold determination unit 12, a comparison unit 13, a schedule determination unit 14, a learning unit 15, and an output unit 16. The acquisition unit 11, the threshold determination unit 12, the comparison unit 13, the schedule determination unit 14, and the output unit 16 implement an acquisition means, a threshold determination means, a comparison means, a schedule determination means, and an output means in the present illustrative example embodiment.

### Acquisition Unit 11

The acquisition unit 11 acquires data supplied from the input/output unit 21 or the communication unit 22. The acquisition unit 11 stores the acquired data in the storage unit 20. As an example, the acquisition unit 11 acquires the first calculation resource amount CR1 and the target language resource amount T_unique. As another example, the acquisition unit 11 acquires the training data TD in which the second calculation resource amount CR2 and the second threshold TH2 are paired as a set.

### Threshold Determination Unit 12

The threshold determination unit 12 determines a first threshold TH1. The threshold determination unit 12 stores the determined first threshold TH1 in the storage unit 20. As an example, the threshold determination unit 12 determines the first threshold TH1 with reference to the first calculation resource amount CR1. As an example of the configuration, the threshold determination unit 12 determines the first threshold TH1 using the training data TD. With this configuration, the threshold determination unit 12 can determine the first threshold TH1 with reference to the value of the training data TD calculated by the preliminary experiment or the like, and thus can determine an appropriate first threshold TH1.

As an example of a method in which the threshold determination unit 12 determines the first threshold TH1 using the training data TD, the threshold determination unit 12 determines the first threshold TH1 using the machine learning model TM trained using the training data TD. More specifically, the threshold determination unit 12 inputs the first calculation resource amount CR1 to the machine learning model TM1, and sets the threshold output from the machine learning model TM as a first threshold TH1. With this configuration, the threshold determination unit 12 can determine an appropriate first threshold TH1.

As another example of the method in which the threshold determination unit 12 determines the first threshold TH1 using the training data TD, in a case where the second calculation resource amount CR2 and the second threshold TH2 included in the training data TD follow a power law, the threshold determination unit 12 determines the first threshold TH1 using a power law model. More specifically, it is assumed that a value T^{*} of the second thresholdTH2 and a value C^{*} of the second calculation resource amount CR2 are set. In this case, in a case where logT^{*} is a linear function of logC^{*}, the threshold determination unit 12 determines the first threshold TH1 by inputting the value of the first calculation resource amount CR1 to the linear function.

### Comparison Unit 13

The comparison unit 13 compares the target language resource amount T_unique with the first threshold TH1, and supplies a comparison result to the schedule determination unit 14. In other words, the comparison unit 13 supplies a comparison result indicating whether the target language resource amount T_unique is equal to or more than the first threshold TH1 to the schedule determination unit 14.

### Schedule Determination Unit 14

The schedule determination unit 14 refers to the first threshold TH1 and determines a schedule of a ratio at which the target language resource amount T_unique is used in the language resource amount used in the LLM learning processing.

More specifically, in a case where the comparison result by the comparison unit 13 indicates that the target language resource amount T_unique is equal to or more than the first threshold TH1, the schedule determination unit 14 determines the schedule for training an LLM as the schedule of multi-epoch learning, which is a one-stage learning method using only the target language in the LLM learning processing. On the other hand, in a case where the comparison result by the comparison unit 13 indicates that the target language resource amount T_unique is less than the first threshold TH1, the schedule determination unit 14 determines the schedule for training an LLM as the schedule of two-stage learning, which is a two-stage learning method using a plurality of languages including a target language and a language different from the target language in the learning processing of an LLM.

With this configuration, the schedule determination unit 14 can determine which of the multi-epoch learning and the two-stage learning is appropriate according to the first calculation resource amount CR1 and the target language resource amount T_unique.

### Learning Unit 15

The learning unit 15 trains a machine learning model. As an example, the learning unit 15 trains the machine learning model TM using the training data TD stored in the storage unit 20. More specifically, in a case where the second calculation resource amount CR2 included in the training data TD is input to the machine learning model TM, the learning unit 15 trains the machine learning model TM so that the threshold output from the machine learning model TM becomes the second threshold TH2 associated with the input second calculation resource amount CR2.

As described above, the second calculation resource amount CR2 included in the training data TD may be smaller than the first calculation resource amount CR1. With this configuration, the learning unit 15 can efficiently train the machine learning model TM since the second calculation resource amount CR2 is smaller than the first calculation resource amount CR1.

The learning unit 15 may train the machine learning model TM by using the training data TD including the number of epochs, the model size of the LLM, the number of training steps, the ratio of the length of learning in the first stage, and the ratio of the target language amount in the first stage and the second stage, in addition to the second calculation resource amount CR2 and the second threshold TH2.

As another example, the learning unit 15 trains the LLM according to the schedule determined by the schedule determination unit 14 using the first calculation resource amount CR1 and the target language resource amount T_unique. As a method for causing the learning unit 15 to train the LLM according to the schedule determined by the schedule determination unit 14, a known method may be used. In a case where the learning unit 15 trains the LLM, the learning unit 15 performs processing of determining a learning setting such as a model size and then trains the LLM on the schedule determined by the schedule determination unit 14.

As still another example, the learning unit 15 may instruct an external device different from the learning method determination device 1A to train the LLM according to the schedule determined by the schedule determination unit 14. In this case, the learning unit 15 may instruct the external device to narrow the range for selecting the learning setting using the schedule determined by the schedule determination unit 14. With this configuration, the learning unit 15 can cause the external device to reduce the search space.

### Output Unit 16

The output unit 16 outputs data via the input/output unit 21 or the communication unit 22. As an example, the output unit 16 outputs information including at least one of the first threshold TH1 and the schedule determined by the schedule determination unit 14. With this configuration, the output unit 16 can notify the user of at least one of the threshold at which the rate for using the target language resource amount T_unique in learning changes and the schedule of the rate for using the target language resource amount T_unique in learning.

### Processing Executed by Learning Method Determination Device 1A

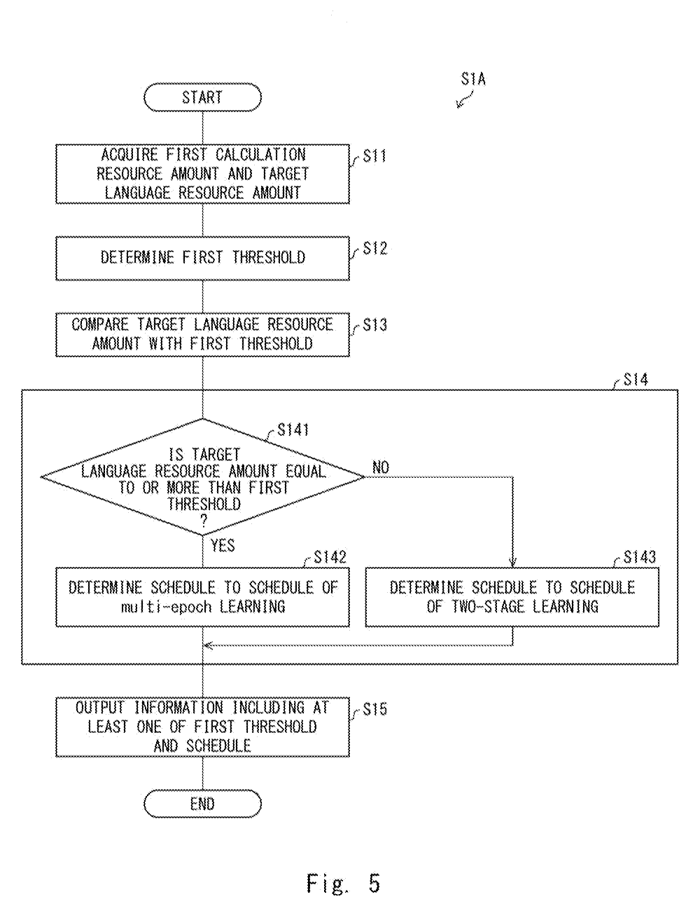

A flow of processing (learning method determination method S1A) executed by the learning method determination device 1A will be described with reference to FIG. 5. FIG. 5 is a flowchart illustrating the flow of the learning method determination method S1A.

### Acquisition Processing S11

In the acquisition processing S11, the acquisition unit 11 acquires the first calculation resource amount CR1 and the target language resource amount T_unique. The acquisition unit 11 stores the acquired first calculation resource amount CR1 and target language resource amount T_unique in the storage unit 20.

### Threshold Determination Processing S12

In a threshold determination processing S12, the threshold determination unit 12 refers to the first calculation resource amount CR1 and determines the first threshold TH1. The threshold determination unit 12 stores the determined first threshold TH1 in the storage unit 20. An example of the process in which the threshold determination unit 12 determines the first threshold TH1 is as described above.

### Comparison Processing S13

In a comparison processing S13, the comparison unit 13 compares the target language resource amount T_unique with the first threshold TH1 determined by the threshold determination unit 12 in the threshold determination processing S12, and supplies a comparison result to the schedule determination unit 14.

Schedule Determination Processing S14

In a schedule determination processing S14, the schedule determination unit 14 determines a schedule of a ratio at which the target language resource amount T_unique is used in the language resource amount used in the LLM learning. As an example, the schedule determination unit 14 executes the following steps S141 to S143 in the schedule determination processing S14.

Step S141

In step S141, the schedule determination unit 14 refers to the comparison result and determines whether the target language resource amount T_unique is equal to or more than the first threshold TH1.

### Step S142

In step S141, in a case where it is determined that the target language resource amount T_unique is equal to or more than the first threshold TH1 (step S141: YES), the schedule determination unit 14 determines the schedule for training the LLM to the schedule of multi-epoch learning, which is a one-stage learning method using only the target language in the learning of the LLM.

### Step S143

In step S141, in a case where it is determined that the target language resource amount T_unique is less than the first threshold TH1 (step S141: NO), the schedule determination unit 14 determines the schedule for training the LLM to the schedule of two-stage learning that is the learning method at two stages using a plurality of languages including the target language and languages different from the target language in the learning of the LLM.

### Output Process S15

In the output process S15, the output unit 16 outputs information including at least one of the first threshold TH1 and the schedule determined by the schedule determination unit 14.

### Specific Example

A specific example of processing executed by the learning method determination device 1A will be described below.

For example, in the acquisition processing S11 described above, the acquisition unit 11 acquires 10^18 FLOP as the first calculation resource amount CR1 and 2×10^10 tokens as the target language resource amount T_unique.

Next, in a threshold determination processing S12, the threshold determination unit 12 refers to the first calculation resource amount CR1 and determines the first threshold TH1.

As an example, in a case where the first threshold TH1 is the 10^9 tokens, in the comparison processing S13, the comparison unit 13 supplies a comparison result indicating that the target language resource amount T_unique is equal to or more than the first threshold TH1 to the schedule determination unit 14.

In this case, in the schedule determination processing S14, the schedule determination unit 14 determines the schedule for training the LLM as a schedule of multi-epoch learning (in other words, the target language ratio is 100%) which is a one-stage learning method using only the target language in the LLM learning.

As another example, in a case where the target language resource amount T_unique acquired by the acquisition unit 11 is the 5×10^8 tokens in the acquisition processing S11, the comparison unit 13 supplies a comparison result indicating that the target language resource amount T_unique is less than the first threshold TH1 to the schedule determination unit 14 in the comparison processing S13.

In this case, in the schedule determination processing S14, the schedule determination unit 14 determines the schedule for training the LLM as a schedule of two-stage learning that is a learning method at two stages using a plurality of languages including a target language and a language different from the target language in the learning of the LLM. As an example, the schedule determination unit 14 determines the ratio of the target language in the first stage to be 100% and the ratio of the target language in the second stage to be 0%.

In a case where the schedule for training the LLM is determined to be the two-stage learning schedule, the schedule determination unit 14 may perform a plurality of times of preliminary learning in which the ratio for using the target language resource amount T_unique is set to different values, and determine the setting of the ratio at which the performance is the best (the loss is small) among the plurality of times of preliminary learning as the schedule for training the LLM.

Then, in the output process S15, the output unit 16 outputs information including at least one of the first threshold TH1 and the schedule determined by the schedule determination unit 14.

### Effects of Learning Method Determination Device 1A

As described above, in the learning method determination device 1A, the learning schedule of the LLM is determined according to the comparison result between the first threshold TH1 determined with reference to the first calculation resource amount CR1 and the target language resource amount T_unique. As described above, the appropriate learning method changes depending on whether the target language resource amount T_unique used for learning is equal to or more than the first threshold TH1 or less than the first threshold TH1. The learning method determination device 1A can determine an appropriate learning schedule with reference to the comparison result between the first threshold TH1 and the target language resource amount T_unique, so that the LLM can be efficiently trained.

The learning method determination device 1A determines the learning schedule of the LLM, thereby reducing the search space in a case where the device that trains the LLM determines another learning setting (for example, a model size or the like). Therefore, the learning method determination device 1A can reduce the processing of the device that trains LLM.

### Achievement Example by Software

Some or all of the functions of the learning method determination devices 1 and 1A (hereinafter, also referred to as “each of the above devices”) may be implemented by hardware such as an integrated circuit (an IC chip) or may be implemented by software.

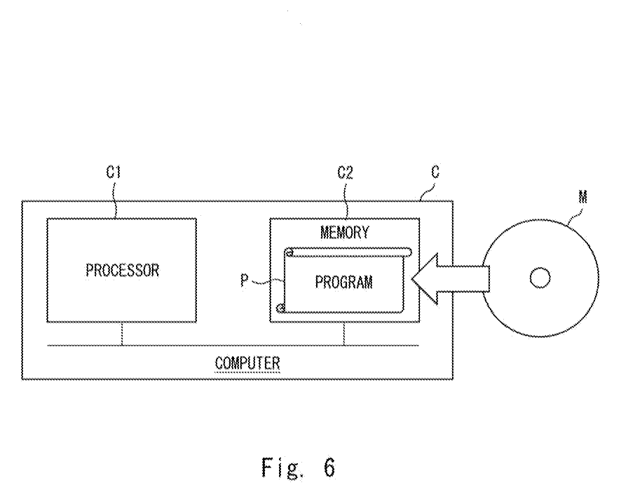

In the latter case, each of the above devices is achieved by, for example, a computer that executes a command of a program as software for achieving each function. An example of such a computer (hereinafter, referred to as a computer C) is illustrated in FIG. 6. FIG. 6 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information A

The present disclosure includes technologies described in the following Supplementary Notes. However, the present disclosure is not limited to the technologies described in the following Supplementary Notes, and various modifications can be made within the scope described in the claims.

### Supplementary Note A1

A learning method determination device including

an acquisition means for acquiring a first calculation resource amount that is a constraint on a calculation resource amount used for learning processing of a language model for a target language and a target language resource amount that is a resource amount of the target language available in the learning processing,

a threshold determination means for determining a first threshold to be referred to for determining a schedule of a rate at which the target language resource amount is used in the language resource amount used in the learning processing of the language model with reference to the first calculation resource amount,

a comparison means for comparing the target language resource amount with the first threshold, and

a schedule determination means for determining the schedule with reference to a comparison result by the comparison means.

### Supplementary Note A2

The learning method determination device according to Supplementary Note A1, in which

the acquisition means further acquires training data in which a second calculation resource amount and a second threshold are paired to be a set, and

the threshold determination means determines the first threshold using the training data.

### Supplementary Note A3

The learning method determination device according to Supplementary Note A2, further including a learning unit that trains a machine learning model using the training data in such a way as to output a threshold relevant to the calculation resource amount as an input,

in which the threshold determination means determines the first threshold using the machine learning model.

### Supplementary Note A4

The learning method determination device according to Supplementary Notes A2 or A3, in which the second calculation resource amount is smaller than the first calculation resource amount.

### Supplementary Note A5

The learning method determination device according to any one of Supplementary Notes A1 to A4, in which

in a case where the comparison result indicates that the target language resource amount is equal to or more than the first threshold, in the schedule determination means, the schedule is determined as a schedule of a one-stage learning method using only the target language in the learning processing of the language model, and

in a case where the comparison result indicates that the target language resource amount is less than the first threshold, in the schedule determination means, the schedule is determined as a schedule of a two-stage learning method using a plurality of languages including the target language and languages different from the target language in the learning processing of the language model.

### Supplementary Note A6

The learning method determination device according to any one of Supplementary Notes A1 to A5, further including output means for outputting information indicating at least one of the first threshold and a schedule determined by the schedule determination means.

### Supplementary Information B

The present disclosure includes technologies described in the following Supplementary Notes. However, the present disclosure is not limited to the technologies described in the following Supplementary Notes, and various modifications can be made within the scope described in the claims.

### Supplementary Note B1

A learning method determination method including:

acquisition processing of acquiring, by at least one processor, a first calculation resource amount that is a constraint on a calculation resource amount used for learning processing of a language model for a target language and a target language resource amount that is a resource amount of the target language available in the learning processing;

threshold determination processing of determining, by the at least one processor, a first threshold to be referred to for determining a schedule of a rate at which the target language resource amount is used in the language resource amount used in the learning processing of the language model with reference to the first calculation resource amount;

comparison processing of comparing, by the at least one processor, the target language resource amount with the first threshold; and

schedule determination processing of determining, by the at least one processor, the schedule with reference to a comparison result in the comparison processing.

### Supplementary Note B2

The learning method determination method according to Supplementary Note B1, in which

in the acquisition processing, the at least one processor further acquires training data in which a second calculation resource amount and a second threshold are paired to be a set, and

in the threshold determination processing, the at least one processor determines the first threshold using the training data.

### Supplementary Note B3

The learning method determination method according to Supplementary Note B2, further including learning processing of training, by the at least one processor, a machine learning model using the training data in such a way as to output a threshold relevant to the calculation resource amount as an input,

in which in the threshold determination processing, the at least one processor determines the first threshold using the machine learning model.

### Supplementary Note B4

The learning method determination method according to Supplementary Notes B2 or B3, in which the second calculation resource amount is smaller than the first calculation resource amount.

### Supplementary Note B5

The learning method determination method according to any one of Supplementary Notes B1 to B4, in which

in a case where the comparison result indicates that the target language resource amount is equal to or more than the first threshold, in the schedule determination processing, the at least one processor determines the schedule as a schedule of a one-stage learning method using only the target language in the learning processing of the language model, and

in a case where the comparison result indicates that the target language resource amount is less than the first threshold, in the schedule determination processing, the at least one processor determines the schedule as a schedule of a two-stage learning method using a plurality of languages including the target language and languages different from the target language in the learning processing of the language model.

### Supplementary Note B6

The learning method determination method according to any one of Supplementary Notes B1 to B5, further including output processing of outputting, by the at least one processor, information indicating at least one of the first threshold and a schedule determined by the schedule determination processing.

### Supplementary Information C

The present disclosure includes technologies described in the following Supplementary Notes. However, the present disclosure is not limited to the techniques described in the following supplementary notes, and various modifications can be made within the scope described in the claims.

### Supplementary Note C1

A learning method determination program for causing a computer to function as a learning method determination device, in which the computer functions as:

an acquisition means for acquiring a first calculation resource amount that is a constraint on a calculation resource amount used for learning processing of a language model for a target language and a target language resource amount that is a resource amount of the target language available in the learning processing;

a threshold determination means for determining a first threshold to be referred to for determining a schedule of a rate at which the target language resource amount is used in the language resource amount used in the learning processing of the language model with reference to the first calculation resource amount;

a comparison means for comparing the target language resource amount with the first threshold; and

a schedule determination means for determining the schedule with reference to a comparison result by the comparison means.

### Supplementary Note C2

The learning method determination program according to Supplementary Note C1, in which

the acquisition means further acquires training data in which a second calculation resource amount and a second threshold are paired to be a set, and

the threshold determination means determines the first threshold using the training data.

### Supplementary Note C3

The learning method determination program according to Supplementary Note C2, further including a learning unit that trains a machine learning model using the training data in such a way as to output a threshold relevant to the calculation resource amount as an input,

in which the threshold determination means determines the first threshold using the machine learning model.

### Supplementary Note C4

The learning method determination program according to Supplementary Notes C2 or C3, in which the second calculation resource amount is smaller than the first calculation resource amount.

### Supplementary Note C5

The learning method determination program according to any one of Supplementary Notes C1 to C4, in which

in a case where the comparison result indicates that the target language resource amount is equal to or more than the first threshold, in the schedule determination means, the schedule is determined as a schedule of a one-stage learning method using only the target language in the learning processing of the language model, and

in a case where the comparison result indicates that the target language resource amount is less than the first threshold, in the schedule determination means, the schedule is determined as a schedule of a two-stage learning method using a plurality of languages including the target language and languages different from the target language in the learning processing of the language model.

### Supplementary Note C6

The learning method determination program according to any one of Supplementary Notes C1 to C5, in which the computer is further caused to function as an output means for outputting information indicating at least one of the first threshold and a schedule determined by the schedule determination means.

### Supplementary Information D

The present disclosure includes technologies described in the following Supplementary Notes. However, the present disclosure is not limited to the techniques described in the following supplementary notes, and various modifications can be made within the scope described in the claims.

### Supplementary Note D1

A learning method determination device including at least one processor, in which the at least one processor executes:

acquisition processing of acquiring a first calculation resource amount that is a constraint on a calculation resource amount used for learning processing of a language model for a target language and a target language resource amount that is a resource amount of the target language available in the learning processing;

threshold determination processing of determining a first threshold to be referred to for determining a schedule of a rate at which the target language resource amount is used in the language resource amount used in the learning processing of the language model with reference to the first calculation resource amount;

comparison processing of comparing the target language resource amount with the first threshold; and

schedule determination processing of determining the schedule with reference to a comparison result in the comparison processing.

The learning method determination device may further include a memory. The memory may store a program for causing the at least one processor to execute each of the processing.

### Supplementary Note D2

The learning method determination device according to Supplementary Note D1, in which

in the acquisition processing, the at least one processor further acquires training data in which a second calculation resource amount and a second threshold are paired to be a set, and

in the threshold determination processing, the at least one processor determines the first threshold using the training data.

### Supplementary Note D3

The learning method determination device according to Supplementary Note D2, in which

the at least one processor further executes learning processing of training a machine learning model using the training data in such a way as to output a threshold relevant to the calculation resource amount as an input, and

in the threshold determination processing, the at least one processor determines the first threshold using the machine learning model.

### Supplementary Note D4

The learning method determination device according to Supplementary Notes D2 or D3, in which the second calculation resource amount is smaller than the first calculation resource amount.

### Supplementary Note D5

The learning method determination device according to any one of Supplementary Notes D1 to D4, in which

in a case where the comparison result indicates that the target language resource amount is equal to or more than the first threshold, in the schedule determination processing, the at least one processor determines the schedule as a schedule of a one-stage learning method using only the target language in the learning processing of the language model, and

in a case where the comparison result indicates that the target language resource amount is less than the first threshold, in the schedule determination processing, the at least one processor determines the schedule as a schedule of a two-stage learning method using a plurality of languages including the target language and languages different from the target language in the learning processing of the language model.

### Supplementary Note D6

The learning method determination device according to any one of Supplementary Notes D1 to D5, in which the at least one processor further executes output processing of outputting information indicating at least one of the first threshold and a schedule determined by the schedule determination processing.

### Supplementary Information E

The present disclosure includes technologies described in the following Supplementary Notes. However, the present disclosure is not limited to the techniques described in the following supplementary note, and various modifications can be made within the scope described in the claims.

### Supplementary Note E1

A non-transitory recording medium having stored therein a learning method determination program for causing a computer to function as a learning method determination device, the computer executing:

an acquisition processing of acquiring a first calculation resource amount that is a constraint on a calculation resource amount used for learning processing of a language model for a target language and a target language resource amount that is a resource amount of the target language available in the learning processing;

a threshold determination processing of determining a first threshold to be referred to for determining a schedule of a rate at which the target language resource amount is used in the language resource amount used in the learning processing of the language model with reference to the first calculation resource amount;

a comparison processing of comparing the target language resource amount with the first threshold; and

a schedule determination processing of determining the schedule with reference to a comparison result by the comparison processing.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A learning method determination device comprising:
a memory that stores instructions; and
a processor configured, according to the instructions, to execute:
acquiring a first calculation resource amount and a target language resource amount, the first calculation resource amount being a constraint on a calculation resource amount used for learning processing of a language model for a target language, the target language resource amount being a resource amount of the target language available in the learning processing;
determining a first threshold to be referred to for determining a schedule of a rate at which the target language resource amount is used in the language resource amount used in the learning processing of the language model with reference to the first calculation resource amount;
comparing the target language resource amount with the first threshold; and
determining the schedule with reference to a comparison result.

2. The learning method determination device according to claim 1, wherein
the acquiring further includes acquiring training data in which a second calculation resource amount and a second threshold are paired to be a set, and
the determining of the first threshold includes determining the first threshold using the training data.

3. The learning method determination device according to claim 2, wherein
the processor is further configured, according to the instructions, to execute training a machine learning model by using the training data so as to output a threshold relevant to a calculation resource amount as an input, and
the determining of the first threshold includes determining the first threshold using the machine learning model.

4. The learning method determination device according to claim 2, wherein the second calculation resource amount is smaller than the first calculation resource amount.

5. The learning method determination device according to claim 1, wherein
in a case where the comparison result indicates that the target language resource amount is equal to or more than the first threshold, the determining of the schedule includes determining the schedule as a schedule of a one-stage learning method using only the target language in the learning processing of the language model, and
in a case where the comparison result indicates that the target language resource amount is less than the first threshold, the determining of the schedule includes determining the schedule as a schedule of a two-stage learning method using a plurality of languages including the target language and languages different from the target language in the learning processing of the language model.

6. The learning method determination device according to claim 1, wherein the processor is further configured, according to the instructions, to execute outputting information indicating at least one of the first threshold and a schedule determined by the determining of the schedule.

7. A learning method determination method comprising:
acquisition processing of acquiring, by at least one processor, a first calculation resource amount that is a constraint on a calculation resource amount used for learning processing of a language model for a target language and a target language resource amount that is a resource amount of the target language available in the learning processing;
threshold determination processing of determining, by the at least one processor, a first threshold to be referred to for determining a schedule of a rate at which the target language resource amount is used in the language resource amount used in the learning processing of the language model with reference to the first calculation resource amount;
comparison processing of comparing, by the at least one processor, the target language resource amount with the first threshold; and
schedule determination processing of determining, by the at least one processor, the schedule with reference to a comparison result in the comparison processing.

8. The learning method determination method according to claim 7, wherein
in the acquisition processing, training data in which a second calculation resource amount and a second threshold are paired to be a set is further acquired, and
in the threshold determination processing, the first threshold is determined using the training data.

9. The learning method determination method according to claim 8, further comprising learning processing of training a machine learning model using the training data in such a way as to output a threshold relevant to the calculation resource amount as an input,
wherein in the threshold determination processing, the first threshold is determined using the machine learning model.

10. The learning method determination method according to claim 8, wherein the second calculation resource amount is smaller than the first calculation resource amount.

11. The learning method determination method according to claim 7, wherein
in a case where the comparison result indicates that the target language resource amount is equal to or more than the first threshold, in the schedule determination processing, the schedule is determined as a schedule of a one-stage learning method using only the target language in the learning processing of the language model, and
in a case where the comparison result indicates that the target language resource amount is less than the first threshold, in the schedule determination processing, the schedule is determined as a schedule of a two-stage learning method using a plurality of languages including the target language and languages different from the target language in the learning processing of the language model.

12. The learning method determination method according to claim 7, further comprising output processing of outputting information indicating at least one of the first threshold and a schedule determined by the schedule determination processing.

13. A non-transitory computer readable medium having stored therein a learning method determination program for supporting decision making to cause a computer to function as a learning method determination device, wherein the computer functions as:
an acquisition means for acquiring a first calculation resource amount that is a constraint on a calculation resource amount used for learning processing of a language model for a target language and a target language resource amount that is a resource amount of the target language available in the learning processing;
a threshold determination means for determining a first threshold to be referred to for determining a schedule of a rate at which the target language resource amount is used in the language resource amount used in the learning processing of the language model with reference to the first calculation resource amount;
a comparison means for comparing the target language resource amount with the first threshold; and
a schedule determination means for determining the schedule with reference to a comparison result by the comparison means.

14. The non-transitory computer readable medium having stored therein a learning method determination program for supporting decision making according to claim 13,
wherein the acquisition means further acquires training data in which a second calculation resource amount and a second threshold are paired to be a set, and
the threshold determination means determines the first threshold using the training data.

15. The non-transitory computer readable medium having stored therein a learning method determination program for supporting decision making according to claim 14, further comprising a learning means for training a machine learning model using the training data in such a way as to output a threshold relevant to the calculation resource amount as an input,
wherein the threshold determination means determines the first threshold using the machine learning model.

16. The non-transitory computer readable medium having stored therein a learning method determination program for supporting decision making according to claim 14, wherein the second calculation resource amount is smaller than the first calculation resource amount.

17. The non-transitory computer readable medium having stored therein a learning method determination program for supporting decision making according to claim 13, wherein
in a case where the comparison result indicates that the target language resource amount is equal to or more than the first threshold, in the schedule determination means, the schedule is determined as a schedule of a one-stage learning method using only the target language in the learning processing of the language model, and
in a case where the comparison result indicates that the target language resource amount is less than the first threshold, in the schedule determination means, the schedule is determined as a schedule of a two-stage learning method using a plurality of languages including the target language and languages different from the target language in the learning processing of the language model.

18. The non-transitory computer readable medium having stored therein a learning method determination program for supporting decision making according to claim 13, further comprising an output means for outputting information indicating at least one of the first threshold and a schedule determined by the schedule determination means.
